(19) United States
(12) Patent Application Publication
(10) Pub. No.: US 2026/0052031 A1
(43) Pub. Date: Feb. 19, 2026

(54) VIDEO CONFERENCE PARTICIPANT PRIORITIZATION

(71) Applicant: East Coast IP, LLC, Raleigh, NC (US)

(72) Inventor: Russell Speight VanBlon, Raleigh, NC (US)

(21) Appl. No.: 18/802,644

(22) Filed: Aug. 13, 2024

(51) Int. Cl. H04L 12/18

(52) U.S. Cl. CPC H04L 12/1822

(57) ABSTRACT

Present principles are directed in part to prioritizing different participant videos during a video conference between remotely-located participants. For example, presentation of first video of a first video conference participant can be prioritized over second video of a second video conference participant based on one or more criteria not necessarily having to do with the first video conference participant currently speaking as part of the video conference. Therefore, in various particular non-limiting implementations, the one or more criteria can include the first video conference participant non-verbally expressing a particular emotion, making a particular non-verbal gesture, and/or having a connection outside the video conference to a viewer of the first video.

### FIELD

The disclosure below relates to technically inventive, non-routine solutions that are necessarily rooted in computer technology and that produce concrete technical improvements. In particular, the disclosure below relates to prioritizing video of different video conference participants.

### BACKGROUND

As recognized herein, video conferences present a unique set of technical issues that do not exist for in-person conferences. For example, video conferences might present video of an active speaker during the video conference, but this itself has many drawbacks. One drawback is that viewers can miss important visual cues from other participants that might indicate the other participant’s own participation and engagement in the video conference despite that participant not actively speaking. Another drawback is that there is often latency between when the next active speaker begins to speak and when the video actually switches to that person, similarly raising the potential for important non-verbal cues to be missed. Current video conference solutions lack the technical capability to address these issues that are unique to digital video conferencing.

### SUMMARY

Thus, present principles are directed in part to prioritizing different participant videos during a digital video conference between remotely-located participants. For example, presentation of first video of a first video conference participant can be prioritized over second video of a second video conference participant based on one or more criteria not necessarily having to do with the first video conference participant currently speaking as part of the video conference. Therefore, in various particular non-limiting implementations, the one or more criteria can include the first video conference participant non-verbally expressing a particular emotion, making a particular non-verbal gesture, and/or having a connection outside the video conference to a viewer of the first video within the video conference.

Accordingly, in one aspect an apparatus includes a processor system and storage accessible to the processor system. The storage includes instructions executable by the processor system to facilitate a video conference. The instructions are also executable to, during facilitation of the video conference, prioritize presentation of first video of a first video conference participant over second video of a second video conference participant based on one or more criteria other than the first video conference participant speaking and/or other than a client device of the first video conference participant transmitting audio data indicating the first video conference participant as speaking.

In some examples, the one or more criteria may include the first video conference participant expressing an emotion that includes laughter, happiness, sadness, crying, and/or cheering. Thus, in one particular implementation, the instructions may be executable to determine, in a first instance, that the emotion the first video conference participant is expressing is related to the video conference. Based on the determination in the first instance, the instructions may then be executable to prioritize presentation of the first video. Yet the instructions may also be executable to determine, in a second instance, that the emotion the first video conference participant is expressing is not related to the video conference. Based on that determination, the instructions may be executable to not prioritize presentation of the first video.

The instructions may additionally or alternatively be executable to group different video of different respective video conference participants into two groups for presentation. The two groups may include a first group that includes video of video conference participants classified as happy, and a second group that includes video of video conference participants classified as sad. The instructions may then be executable to present the first and second groups separately from each other on a graphical user interface (GUI) of the video conference.

What’s more, the instructions may additionally or alternatively be executable to deprioritize third video of a third video conference participant based on factors such as the third video conference participant being classified as distracted, the third video conference participant not being currently shown in the third video, the third video conference participant being identified as looking in a direction away from a camera that generates the third video, and/or another person besides the third video conference participant coming into view in the third video. The third video conference participant may be the same as or different from the second video conference participant.

In addition to or in lieu of expressing an emotion as set forth above, the one or more criteria for prioritizing the first video may include the first video conference participant making a gesture, such as a hand raise gesture or a thumbs up gesture. In addition to or in lieu of that, the one or more criteria may include the first video conference participant being a member of a same organization as the third video conference participant such that the first video is prioritized as presented to the third video conference participant but not prioritized for a fourth video conference participant of the video conference. As yet another example, the one or more criteria may include the first video conference participant and the third video conference participant being members of a same social media group such that the first video is prioritized as presented to the third video conference participant but not prioritized for the fourth video conference participant of the video conference. As still another example, the one or more criteria may include the first video and third video of the third video conference participant both showing a same object and/or respective objects of a same object type. Any and/or all of the foregoing criteria may be combined together and used concurrently with each other in any given example embodiment, which may enhance accuracy of the system and reduce false positives where a video feed might otherwise be prioritized incorrectly.

Still further, in some implementations the apparatus itself may include a server facilitating the video conference at least in part by routing audio video communications between client devices of respective video conference participants. Additionally or alternatively, the apparatus may include a first client device facilitating the video conference by transmitting local audio video to the server and/or to other client devices of other respective video conference participants. Thus, in some implementations the apparatus may include either of the server and first client device. In other implementations, the apparatus may include both the server and the first client device (and even other client devices also participating in the same video conference).

Also note that, in various non-limiting implementations, prioritizing presentation of the first video over the second video may include presenting the first video higher up on a graphical user interface (GUI) than the second video. Prioritizing presentation of the first video over the second video may also include presenting the first video larger on the GUI than the second video, presenting the first video more to the left than the second video according to a video listing, presenting the first video on the GUI but not concurrently presenting the second video on the GUI, and/or highlighting the first video on the GUI. The highlighting may include presenting a first color along a border of the first video and/or presenting a graphic overlay in relation to the first video.

In another aspect, a method includes facilitating a video conference. The method also includes, during facilitation of the video conference, prioritizing presentation of first video of a first video conference participant over second video of a second video conference participant based on one or more criteria other than the first video conference participant actively speaking.

Thus, in one example, the one or more criteria may include the first video conference participant visually and/or non-verbally expressing a particular emotion.

Additionally, prioritizing presentation of the first video over the second video may include presenting the first video higher up on a graphical user interface (GUI) than the second video. Prioritizing presentation of the first video over the second video may also include presenting the first video larger on the GUI than the second video, presenting the first video more to the left than the second video according to a video listing, presenting the first video on the GUI but not concurrently presenting the second video on the GUI, and/or highlighting the first video on the GUI. The highlighting may include presenting a first color along a border of the first video and/or presenting a graphic overlay in relation to the first video.

Still further, in some examples, in addition to prioritizing the first video, the method may include concurrently deprioritizing third video of a third video conference participant based on another person besides the third video conference participant coming into view in the third video. The third video conference participant may be the same as or different from the second video conference participant.

In still another aspect, an apparatus includes at least one computer readable storage medium (CRSM) that is not a transitory signal. The at least one CRSM includes instructions executable by a processor system to facilitate a video conference. The instructions are also executable to, during facilitation of the video conference, prioritize presentation of first video of a first video conference participant based on one or more criteria other than the first video conference participant currently speaking.

For example, the one or more criteria may include the first video conference participant non-verbally expressing a particular emotion.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIGS. 2-4 and 8 shows example video conferencing graphical user interfaces (GUIs) that may be presented in real-time during a video conference and which may dynamically change/update according to principles set forth below;

FIG. 5 shows example logic in example flow chart format that may be executed by a system/apparatus consistent with present principles;

FIGS. 6 and 7 show example opt-in GUIs that may be presented to a video conference participant prior to and/or while entering a video conference for the participant to opt-in to various aspect of present principles;

FIG. 9 shows an example GUI that may be presented to a participant for the participant to search for and establish different metadata tags for prioritizing and/or grouping participants of a video conference consistent with present principles;

FIG. 10 shows an example settings GUI that may be used to configure one or more settings of a system/apparatus to operate consistent with present principles; and

FIG. 11 shows an example GUI that may be presented to a video conference organizer or moderator when another participant requests deprioritization consistent with present principles.

### DETAILED DESCRIPTION

Present principles are directed in part to prioritizing different participant videos during a video conference between remotely-located participants. For example, presentation of first video of a first video conference participant can be prioritized over second video of a second video conference participant based on one or more criteria not necessarily having to do with the first video conference participant currently speaking as part of the video conference. Therefore, in various particular non-limiting implementations, the one or more criteria can include the first video conference participant non-verbally expressing a particular emotion, making a particular non-verbal gesture, and/or having a connection outside the video conference to a viewer of the first video.

Prior to delving further into the details of the instant techniques, note that this disclosure relates generally to aspects of consumer electronics (CE) devices and other types of client devices and servers. Thus, devices herein may include server and client components which may be connected over a network such that data may be exchanged between the client and server components. The client components may include one or more computing devices including mobile smart phones and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single- or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Note that present principles may also employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as one or more convolutional neural networks (CNNs) and/or one or more recurrent neural networks (RNNs) (such as a type of RNN known as a long short-term memory (LSTM) network). Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that are configured and weighted to make inferences about an appropriate output.

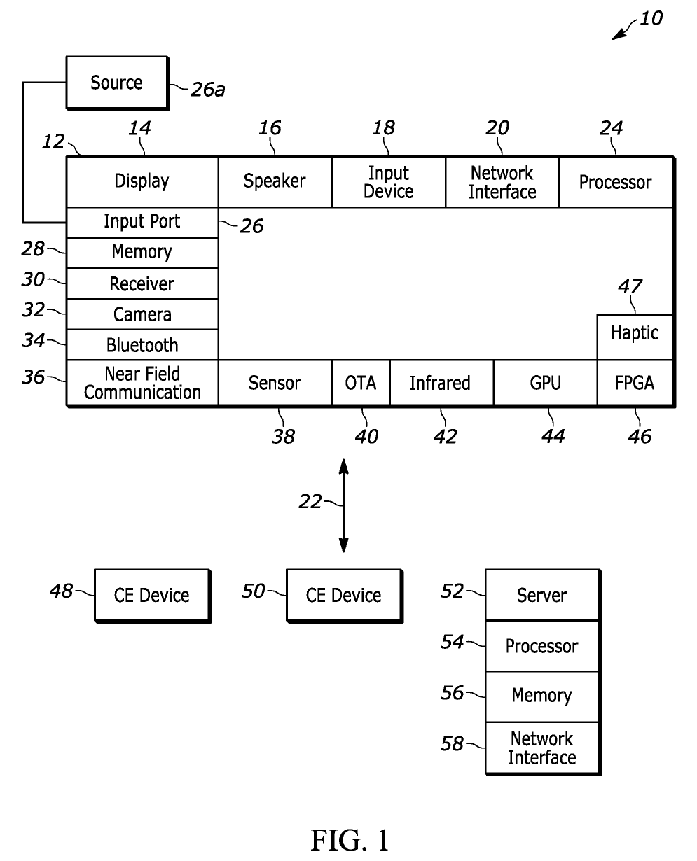

Referring now to FIG. 1, an example system 10 is shown, which may include one or more of the example apparatuses/devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles, and at least one additional input device 18 such as an audio receiver/microphone, e.g., for conversing telephonically or for entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface.

It is to be understood that the processor system 24 may include one or more processors acting independently or in concert with each other to execute an algorithm (e.g., the algorithms referenced herein), whether those processors are in one device or more than one device. Thus, in some specific examples, the processor system may include a single processor, while in other examples the processor system may include more than one processor. The processor system 24 controls the CE device 12 to undertake present principles, including the other elements of the CE device 12 described herein such as controlling the display 14 to present images thereon and receiving input therefrom. Furthermore, also note the network interface 20 may be a wired or wireless modem or router or other suitable network interface.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 to a user through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals, in some cases embodied in the chassis/housing of the CE device 12 (e.g., as standalone devices) or as removable memory media or the below-described server(s). Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12. In some examples, the GPS transceiver 30 may be located on a streetlight or other infrastructure for which location is to be reported for purposes described in greater detail below.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth^{®} transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor’s rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Or the CE device 50 may be established by a smart streetlight consistent with present principles and, as such, the smart streetlight may include a network communication interface (e.g., Wi-Fi transceiver and/or cellular data transceiver) for communicating with other devices to implement present principles.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs. UIs may be presented at a client device like the CE device 12 under control of the client device itself and/or under control of the server 52 as remotely controlling the CE device 12 to present the UIs thereon. Also note that selectors and options on the UIs discussed below may be selected via cursor input, touch input to a touch-enabled display on which the GUI is presented, using voice input, and/or using other input methods.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

With the foregoing in mind, it is to be understood that present principles deal in part with prioritizing different participant videos during a video conference between remotely-located participants and even some in-person participants who are co-located together in a same conference room or other real-world location.

For example, presentation of first video of a first video conference participant can be prioritized over second video of a second video conference participant based on one or more criteria not necessarily having to do with the first video conference participant actively/currently speaking as part of the video conference.

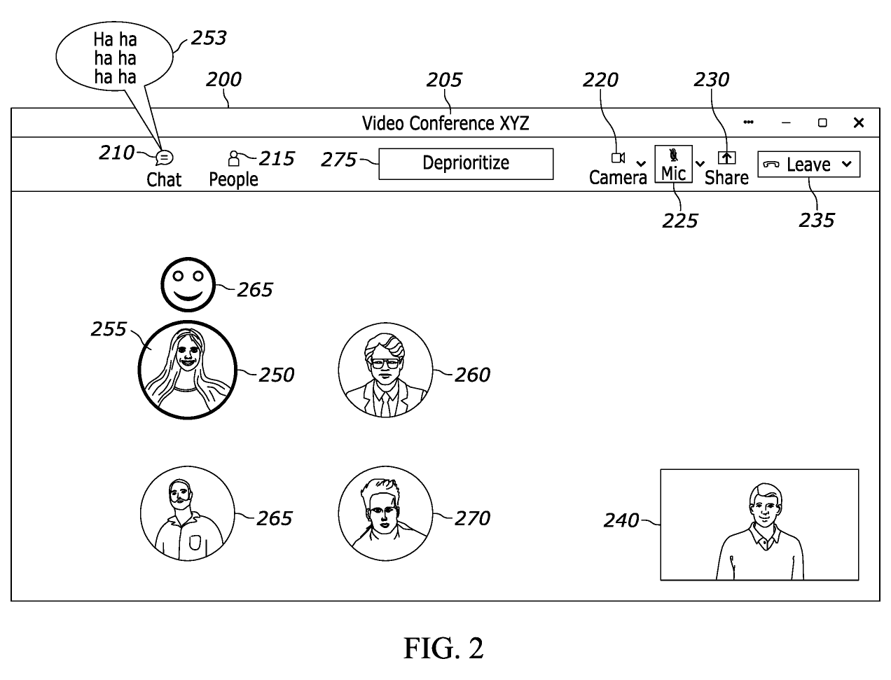

Attention is now drawn to FIG. 2. This figure shows an example video conferencing graphical user interface (GUI) 200 as presented on the display of a client device/CE device of a video conference participant. It is to therefore be understood that the GUI 200 may be presented and updated in real-time as a video conference transpires, presenting video of the different logged-on participants to the video conference as well as data such as texts indicating the current participants, electronic documents shared as part of the video conference, etc.

As shown in FIG. 2, the GUI 200 may include a video conference title 205, a chat selector 210 for the participant to select for engaging in text chat with other participants during the video conference, a participant listing selector that is selectable to present a full listing of all currently logged-on video conference participants, a camera on/off selector 220 to turn the local participant’s local camera on and off, a microphone on/off selector 225 to turn the local participant’s local microphone on and off, a share selector 230 that is selectable for the local participant to share one or more locally-running apps, windows, or other local screens with other participants, and a leave selector 235 that is selectable for the local participant to leave the video conference while the conference continues or to leave immediately after the conference ends. Note that FIG. 2 also shows a local video feed 240 of the local participant to which the GUI 200 is presented. The local participant is therefore understood to be co-located at the same geolocation as that participant’s own client device (and hence the local microphone and local camera on that client device), while remote participants are understood to be located at different geolocations with their own respective client devices.

Also note that the GUI 200 is being presented to a first (local) video conference participant, but consistent with present principles a similar but not identical GUI may be presented to other participants at their own respective client devices. For example, for another participant, not only would the local video feed 240 show a different local camera feed of that different participant themselves, but different additional remote participants beyond that participant may also be prioritized and presented differently than for the first video conference participant consistent with the disclosure herein. Therefore, recognizing the dynamic nature of each local GUI presented to a respective local participant, note that different prioritized remote conference participants and groupings of remote participants may be presented to different local participants via their own respective (local) video conferencing GUI.

With this in mind, assume for the present example that the first (local) participant to which the GUI 200 is presented may have opted-in to prioritizing and deprioritizing their own local audio and video feeds to others at the other participants’ own client devices and, as such, the first participant is also presented with different prioritizations and deprioritizations of the other participants as well. In this way, when the first participant themselves opts in to having their audio and video feeds prioritized/deprioritized to others, they are also presented via the GUI 200 with dynamic prioritized/deprioritized audio video (AV) feeds of other participants that have similarly opted-in.

As for prioritization of the video of one remotely-located participant over the video(s) of other remotely-located participants, this may include various ways of presenting the prioritized video to the (local) first participant so that the first participant can discern things from the prioritized video that they might otherwise miss had the respective video not been prioritized. As such, prioritization may include presenting the prioritized video higher up on the GUI 200 than non-prioritized or deprioritized video of still other remotely-located participants that are also presented on the GUI 200. Prioritization may additionally or alternatively include presenting the prioritized video larger in X and/or Y dimensions of the GUI 200 than the other non-prioritized or deprioritized videos, presenting the prioritized video more to the left than the other non-prioritized or deprioritized videos according to a video listing of the one of more of the other video conference participants, presenting the prioritized video on the GUI 200 but not concurrently presenting other non-prioritized or deprioritized video(s) of another participant(s) on the GUI 200, and/or highlighting the prioritized video on the GUI 200.

The highlighting itself may include presenting a first color along a border of the prioritized video that is different from the color(s) presented along the borders of the other non-prioritized or deprioritized videos. Also, the highlighting may include presenting an additional color along the border of the prioritized video even if the other videos have no additional border colors at all. Highlighting may additionally or alternatively include presenting a graphic overlay in relation to the prioritized video. These aspects are shown in FIG. 2, where an additional yellow border 250 is shown surrounding the video feed 255 of a remotely-located participant, while no additional border (or different-colored additional border) is presented for the video feed 260 of another participant that is not currently being prioritized. Additionally, a graphic overlay in the form of a laughing emoji 265 is also presented above the video feed 255 as a form of prioritization.

The laughing emoji 265 is being presented in the present instance based on the recognition that in one example implementation, other participants may be prioritized or deprioritized according to their respective real-world emotions, which might be expressed visually/non-audibly and/or non-verbally. Thus, different emojis corresponding to different emotions may be presented in a given instance to match whatever particular real-world emotion of the respective participant is recognized by the video conferencing system itself (e.g., client device and/or server facilitating the video conference). Accordingly, the laughing emoji 265 is being presented in the present instance based on the participant shown in the feed 255 being classified as laughing (with speech bubble 253 representing the audible real-world laughter of that participant that might have been identified and used by the system to infer the emotion of laughter). As additional examples, a happy-faced emoji may be autonomously presented responsive to classifying a respective participant as being happy, a sad-faced emoji may be autonomously presented responsive to classifying a respective participant as being sad, and an angry-faced emoji may be autonomously presented responsive to classifying a respective participant as being angry.

Video-based emotion recognition may therefore be executed on the video of the respective participant to identify a currently-exhibited emotion of that participant in order to present a corresponding emoji (or other graphic overlay, such as an arrow pointing toward the prioritized video to prioritize that video). Additionally or alternatively, audio-based emotion recognition may be executed on audio of the respective participant to identify a currently-exhibited emotion of that participant. Computer vision-based emotion recognition algorithms may therefore be executed for emotion recognition via video, and natural language processing-based emotion recognition algorithms may be executed for emotion recognition via audio. Other artificial intelligence-based emotion recognition techniques for classifying emotions may also be used. Additionally, note that in some examples, both audio-based and video-based emotion recognition may be executed for the same participant to increase device confidence in an emotion determination for that participant (e.g., to reduce false positives).

Also note that as part of prioritizing the video feed 255, the feed 255 as shown in FIG. 2 is presented to the left of the feed 260 and is also presented higher-up than still other feeds 265, 270 of still other respective participants. The feed 255 is also prioritized in that still other video feeds for still other conference participants are available and are being streamed, but are not currently being presented on the GUI 200 as those other feeds are non-prioritized or deprioritized.

FIG. 2 also shows that a deprioritize selector 275 may also be presented on the GUI 200. The selector 275 may be selected by the local participant via touch input, cursor input, voice input, etc. to command the video conferencing system to deprioritize the video feed of the local participant as presented to other remotely-located participants on their own respective video conference GUIs. Deprioritizing may include various ways of presenting (or not presenting) the deprioritized video so that other participants’ attention is not drawn to that video feed. As such, deprioritization may include presenting the deprioritized video lower on a respective video conference GUI than prioritized video of other remotely-located participants. Deprioritization may additionally or alternatively include presenting the deprioritized video smaller in the X and/or Y dimensions on the GUI than the other non-prioritized or prioritized videos, presenting the deprioritized video more to the right than the other non-prioritized or prioritized videos according to a video listing of the one or more other video conference participants, not presenting the deprioritized video on the GUI at all while presenting other non-prioritized or prioritized videos of other participants, and/or not highlighting the deprioritized video on the GUI. Bases for the video conferencing system to autonomously deprioritize various participants will be discussed in greater detail below.

Also note that responsive to the local participant selecting the deprioritize selector 275, the selector 275 may be dynamically replaced with a prioritize selector to take the local participant out of deprioritization status and again have the system prioritize the participant when triggered by one or more prioritization criteria as met in the future. Additionally or alternatively, deprioritization responsive to selection of the selector 275 may transpire for a threshold non-zero amount of time (e.g., thirty seconds) before deprioritization status ceases and the respective participant goes back to non-prioritization/non-deprioritization, and/or goes back to actual prioritization upon one or more of the prioritization criteria being met.

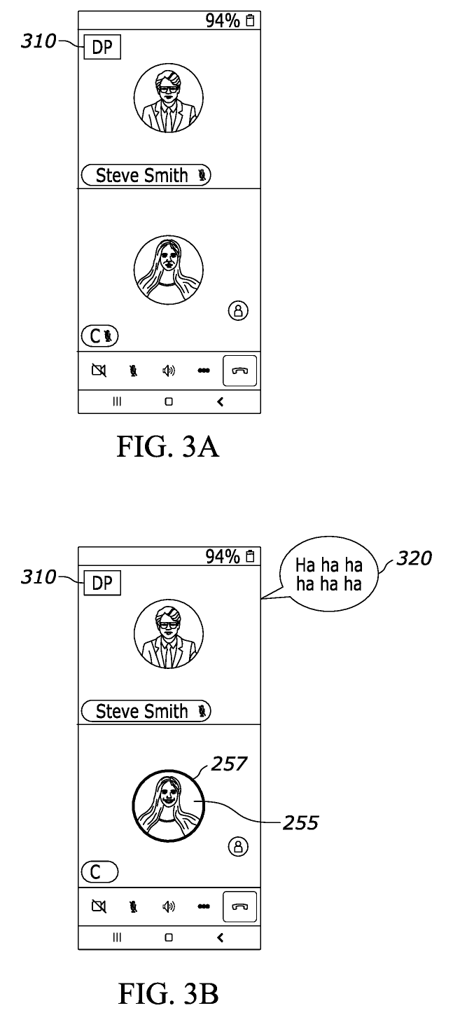

Also, assume for a moment that the GUI 200 of FIG. 2 is a GUI for a desktop presentation of the video conference. Should the local participant instead be using a mobile application on a mobile device such as a smartphone, FIGS. 3A and 3B show that a different GUI 300 may be presented. However, as shown in FIG. 3, the GUI 300 may still include a “DP” selector 310 (standing for “deprioritize”) similar in function and configuration to the selector 275 for the local participant to manually deprioritize themselves. The GUI 300 may also include other features similar to the GUI 200.

FIG. 3A further illustrates that at a first moment in time during the video conference, no participants are prioritized. FIG. 3B then indicates that at a later (second) time, the video stream 255 is prioritized based on the associated participant shown in the stream 255 expressing the emotion of laugher (as further illustrated by the speech bubble 320 that represents the rea-world audible laughter that the local participant would hear as part of the video conference when streamed from the laughing remote participant’s device). Any of the prioritization techniques discussed herein may therefore be used to prioritize the video 255 in the mobile application just as with the desktop embodiment. As such, in the present instance the video 255 is highlighted via an additional yellow border 257 surrounding the video 255.

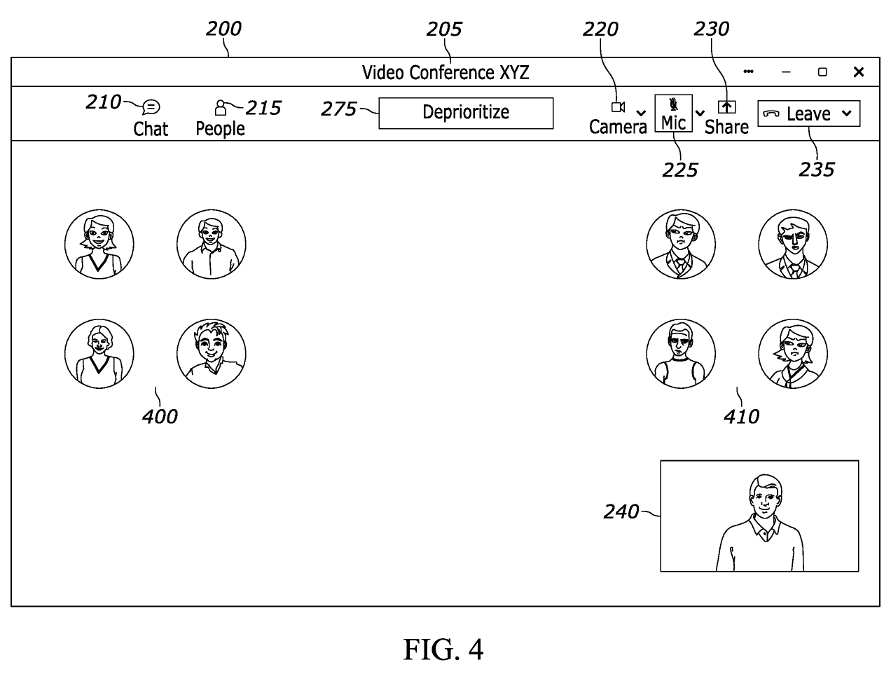

Continuing the detailed description in reference to FIG. 4, and as mentioned above, in some instances various participants of the video conference might be grouped together. The dividing of some or all of the participants into different groupings may also be based on one or more criteria. For example, different participants may be grouped together based on concurrently expressing the same emotion. Different remote participants may also be grouped together based on sharing a common trait with the local participant, such as grouped participants being members of a same organization (e.g., business for which the grouped participants worked) and/or being members of a same social media group (e.g., Facebook group with its own group page, Twitter/X group chat message hosted by that social media network, etc.). Different participants may also be grouped based on other criteria discussed herein, including for example grouping participants whose video feeds all show a same object and/or object type in the background of the respective video feed. Also note that, in some examples, these same criteria for grouping participants may also be used for prioritizing a single given remote participant to a local participant per the description of FIG. 2 above.

In any case, as shown in FIG. 4, a first grouping 400 of participants has now been dynamically presented as part of the GUI 200 based on participants of the first grouping all being classified as concurrently exhibiting the emotion of happiness. Additionally, a second grouping 410 of participants has been dynamically presented as part of the GUI 200 based on participants of the second grouping all being classified as concurrently exhibiting the emotion of sadness, based on being classified as concurrently exhibiting no discernable emotion, and/or based on being classified as concurrently exhibiting other emotions different from happiness (and potentially different from each other). Also note that while the two groupings 400, 410 are separated from each other on the GUI 200 in that the grouping 400 is presented on the left-hand side and the grouping 410 is presented on the right-hand side, in some examples the groupings may be presented at a same general area of the GUI 200 yet still grouped (and hence separately presented) into the groupings 400, 410. For example, a listing of all participants might be shown on the right-hand side, and here the grouping 400 may be presented above the grouping 410 as presented immediately below the grouping 400. Also note that more than two groupings may be presented in some examples, each corresponding to expressions of a different particular emotion.

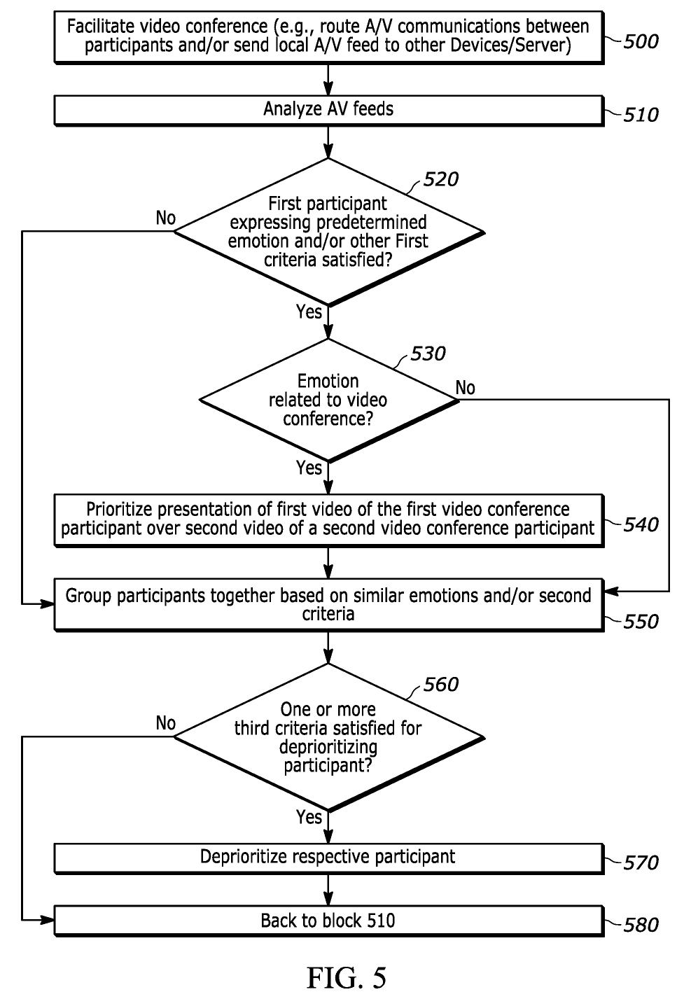

Now in reference to FIG. 5, this figure shows example logic that may be executed by an apparatus such as the CE device 12, a client device, and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 5 is shown in flow chart format, other suitable logic may also be used.

Beginning at block 500, the apparatus may facilitate a video conference. The server mentioned in the paragraph immediately above may therefore facilitate the video conference at least in part by routing audio and video communications (e.g., AV streams) between client devices of respective remotely-located video conference participants. The client device may facilitate the video conference by transmitting local audio and local video feeds to the coordinating server itself and/or to other remotely-located client devices of other respective video conference participants. From block 500 the logic may then proceed to block 510.

At block 510 the apparatus may analyze the AV feeds, including any local AV feed if this step is being executed by the client device. Computer vision may therefore be executed on the video feeds while different audio processing techniques may be executed on the audio feeds. In one particular example, object recognition may be executed on the video feeds to identify different objects/object types shown in the video feeds (objects other than the participants themselves). Video-based emotion recognition algorithms may also be executed on the video feeds, as may facial recognition to thus recognize the different participants by name to then lookup affiliations of the different participants (e.g., for grouping based on same employer or same social media group). The apparatus may therefore have access to the social media networks themselves as well as other data such as organizational charts, webpages, and/or email accounts from which different affiliations may be identified for grouping one participant with another.

Additionally, in terms of audio, audio-based emotion recognition algorithms may be executed on the audio feeds. These algorithms may include natural language processing algorithms, such as natural language understanding algorithms and sentiment analysis algorithms in particular. Additionally, voice recognition algorithms may be executed on the audio to identify participants by name to then lookup affiliations of the different participants as described above.

From block 510 the logic may proceed to decision diamond 520 where, during facilitation of the video conference and based on the emotion analysis at block 510, the apparatus may determine whether a first participant is visually/non-audibly and/or non-verbally expressing a predetermined emotion. Example predetermined emotions for which to prioritize a participant may include, but are not limited to, laughter, happiness, sadness, crying, and cheering. Also note that in addition to or in lieu of an expressed emotion, at diamond 520 the apparatus may determine whether one or more other first (prioritization) criteria are satisfied as described elsewhere herein.

A negative determination at diamond 520 may cause the logic to proceed directly to block 550 as will be described in a moment. However, first note that an affirmative determination at diamond 520 may instead cause the logic to proceed to decision diamond 530 instead.

At diamond 530 the apparatus may determine whether the inferred emotion is related to the video conference itself. For example, natural language processing algorithms may be executed on audio of the video conference, and/or on an uploaded written agenda or email invite for the video conference. This may be done for the apparatus to determine whether the inferred emotion was exhibited based on and in response to something that was discussed or shown as part of the video conference as indicated in the audio or written data, or was instead exhibited for a reason unrelated to the conference (e.g., such as something that happened locally off camera near the relevant participant). As another example, if more than one participant reacts emotionally at the same time or within a threshold amount of time of each other (e.g., within five seconds) as determined via computer vision and/or audio processing, the exhibited emotion(s) may be inferred as related to the video conference, whereas if only one participant exhibits an emotion then the exhibited emotion may be inferred as not related to the video conference. Gesture recognition may also be executed on video from the video conference to identify a particular gesture by one of the participants and emotions that may have been exhibited by others within a threshold amount of time of that gesture to infer the exhibited emotion(s) as being related to the gesture itself. These techniques may therefore also help reduce false positives where an emotion is exhibited and the video feed of that participant is prioritized to others despite the emotion having nothing to do with the video conference itself (and therefore not informing the other participants about anything in relation to the prioritized participant).

Thus, an affirmative determination in a first instance in relation to a given emotion may cause the logic to proceed to block 540 when the emotion is related to the video conference itself, while a negative determination in a second instance in relation to the same emotion may cause the logic to proceed directly to block 550 when the emotion is not related to the video conference.

However, further note that in other non-limiting embodiments, the decision of diamond 530 may not be performed at all. So here, based on an affirmative determination at diamond 520, the logic may proceed directly to block 540.

As for block 540 itself, at this step the apparatus may actually prioritize presentation of first video of a first video conference participant over second video of a second video conference participant based on one or more of the first criteria being satisfied (criteria other than the first video conference participant speaking as an “active speaker” of the conference and/or other than a client device of the first video conference participant transmitting audio data indicating the first video conference participant as speaking). Prioritization at block 540 may include any of the prioritization techniques described above in reference to FIG. 2, for example (e.g., highlighting the first participant’s video). The prioritization may help reduce latency that would otherwise occur when the system might switch videos based on active speakers, since certain non-verbal visual cues might precede the next speaker’s speech and may be used consistent with present principles to preemptively prioritize the video of the next speaker instead of or in addition to the video of the current speaker (e.g., the next speaker smiles and is therefore classified as happy before speaking about whatever subject made them happy). And even if a given participant expresses an emotion and does not speak immediately thereafter (and/or another first criteria is otherwise satisfied), the prioritization can still help others gain a fuller understanding of what is going on with the participants of the video conference.

From block 540 the logic may then proceed to block 550. At block 550, in addition to or in lieu of prioritizing a single participant or more than one participant at block 540, the apparatus may, based on one or more second criteria, group different video of different respective video conference participants into different groups for presentation. So, for example, a first group may be established and presented that includes video of video conference participants classified as happy, while a second group may be established and presented that includes video of conference participants classified as sad. The two groups may then be presented separately from each other on a GUI of the video conference, such as the GUI 200 as described above in reference to FIG. 4.

From block 550 the logic may then proceed to decision diamond 560. At diamond 560 the apparatus may determine whether one or more third criteria are satisfied for deprioritizing one or more participants. Deprioritization at block 560 may include any of the deprioritization techniques described above in reference to FIG. 2, for example (e.g., removing the respective participant’s video from being displayed to others).

As for the third criteria themselves, they may include a number of different things, such as the relevant participant being classified as distracted (e.g., classified through computer vision). The third criteria may also include the relevant participant not being currently shown in their own video, such as if the participant steps away from their local camera and/or is out of its field of view as also determined via computer vision. The third criteria may also include the relevant participant being identified as looking in a direction away from their local camera that generates their video conference video (again identified through computer vision). As another example, the third criteria may include another person (or even animal) besides the relevant participant coming into view in the relevant participant’s video (e.g., coming within the field of view of the participant’s local camera as determined via computer vision or even object recognition in particular). Thus, participants that are not paying attention to the conference, that step away from their client device, and/or that are engaged in non-video conference tasks may be deprioritized. Similarly, if someone else related to the relevant participant walks into the participant’s local environment, or even if the participant’s dog comes into the participant’s local environment, that participant’s video may be deprioritized as presented to other participants at other client devices so as to not draw the other participants’ attention to things unrelated to the video conference and that might embarrass the deprioritized participant themselves.

Still in reference to diamond 560, note that an affirmative determination may cause the logic to proceed to block 570 where the relevant participant’s video is in fact deprioritized then then the logic may return to block 510 for the logic to proceed again therefrom. However, responsive to a negative determination at diamond 560, the logic may instead proceed to block 580 and hence directly back to block 510 to proceed again.

Before moving on to other figures, additional criteria will be discussed that may be used for the first criteria for prioritizing a given video feed of a given conference participant, where those additional first criteria may be used alone or in combination with each other and/or with expression of emotion as another first criterion. Accordingly, in one example the first criteria may also include the relevant video conference participant making a gesture for which others may want to be made aware, such as a hand raise gesture where the participant raises their arm and hand toward, level with, and/or above their head. Another example gesture might be a thumbs up gesture where the participant makes a fist save for sticking their thumb upwards in the air. Still other predetermined gestures using non-head and non-neck body parts may be used as well. Furthermore, in some examples head and neck-related gestures may also be used, such as a head tilts to the left of the right, a left-right head shake as a “no” gesture, and an up-down head shake as a “yes” gesture.

As additional example first criteria, a participant may be prioritized based on being a member of a same organization or social media group as another participant to which the first participant’s video will be prioritized (e.g., even if that video is not prioritized as presented to still other participants not belonging to the same organization). The organization may be a social organization, a work-related or business-related organization, or still another type of organization for which the apparatus has access to data indicating organization members.

Another example first criteria may include the video for both the local participant and a remote participant whose video will be prioritized (to the local participant) both showing a same object and/or respective objects of a same object type. For example, sports objects or musical objects generally may establish different object types, while a same object might include a same coffee mug from a particular university or a baseball in particular. Prioritizing video showing objects of a same type as what is in a local environment of a local participant can thus help the local participant build connections and common ground with other (remote) participants whose video shows similar items.

Furthermore, it is to be understood more generally based on the example first criteria above that, for a same video conference, each local participant’s video conference GUI that shows the other (remote) participants may differ from each other depending on which remote participant video(s) are prioritized, grouped, and/or deprioritized to that respective local participant given the first criteria above.

Also before moving on to the description of other figures, note that in various examples participants may be grouped and/or deprioritized, even if participant prioritization is not implemented or executed in a given instance. Therefore, in various video conference instances, deprioritization alone may be executed, participant grouping alone may be executed, and/or prioritization alone may be executed. Any combinations of those may also be executed in other non-limiting examples.

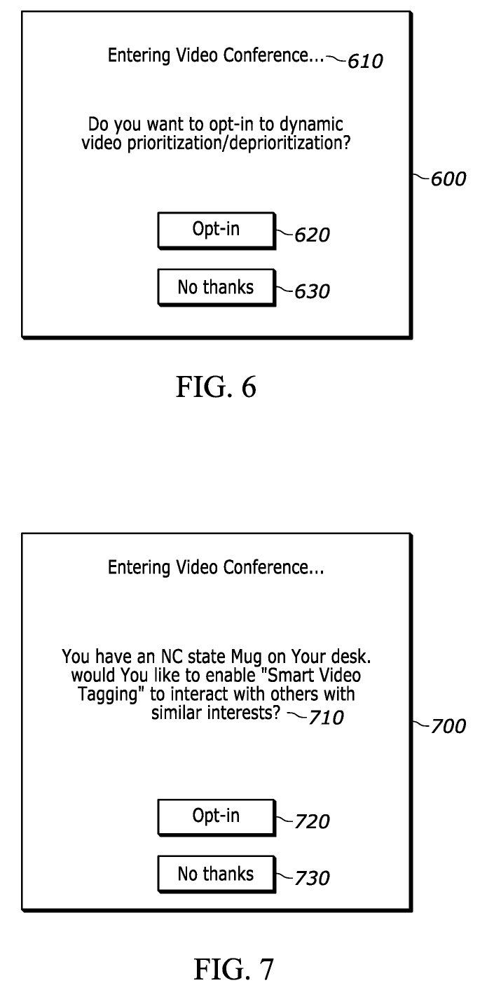

Now in reference to FIG. 6, in some examples to provide participants with greater control over presentation of their own video feeds, participants may be asked to opt-in to prioritization, deprioritization, and/or grouping prior to entering/beginning a particular video conference. FIG. 6 therefore shows a GUI 600 with a prompt 610 indicating that the participant is about to enter the video conference and asking whether the participant wants to opt-in. Selector 620 may therefore be selected to respond in the affirmative, opting in to prioritization, deprioritization, and/or grouping. Additionally, selector 630 may be selected to respond in the negative, opting out of having their local video prioritized, deprioritized, and/or grouped as presented to other participants at other client devices.

The GUI 700 of FIG. 7 may be presented instead as another opt-in prior to entering the video conference (without the GUI 600 being presented first), or in some instances the GUI 700 may be presented responsive to a general opt-in via selection of the selector 620 of FIG. 6. In either case, the GUI 700 may be presented responsive to the system identifying a same object type in the local participant’s camera’s field of view as also shown in another (remote) participant’s camera’s field of view. As such, the GUI 700 may include a prompt 710 indicating that the same object type (in this case, an NC State-related item) is sitting on the local participant’s desk (as identified via computer vision, for example). The prompt 710 also asks whether the local participant would like to enable a Smart Video Tagging feature for grouping the local participant with other conference participants with a similar inferred interest (in this case, NC State being the inferred interest), as might have been determined from NC State items in the video of the other remote participants.

Selector 720 may therefore be selected to respond in the affirmative, opting in to enable Smart Video Tagging for grouping the local participant with other participants assigned similar metadata tags by the conferencing system (NC State being the metadata tag in this example). Additionally, selector 730 may be selected to respond in the negative, opting out instead.

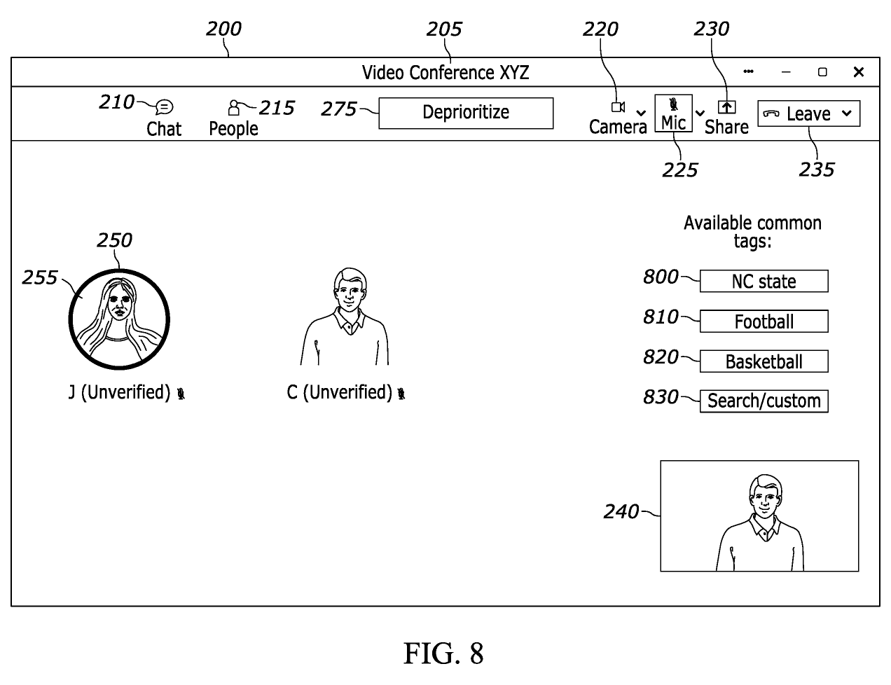

Continuing the description of Smart Video Tagging consistent with present principles, reference is now made to FIG. 8. Here, the GUI 200 is again presented. But here, the GUI 200 as presented to the local participant presents selectors 800-820, each of which corresponds to a different metadata tag indicating a different respective correlation between the local participant and at least one remote participant that is also currently in the video conference. Metadata tags indicating participant interest correlations may be identified not just through similar objects shown in each participant’s field of view as determined through computer vision, but through other techniques as well. For example, social media likes and dislikes may be accessed to determine the participants have the same interests as indicated by liking/disliking the same things on social media. Data from other sources may also be accessed, such as websites, emails, and notes of the respective participants that are accessible to the conferencing system. Keyword correlations, and/or correlations using natural language processing and semantic understanding, may then be used to identify common interests amongst certain participants.

Thus, in the example of FIG. 8, the determined metadata tags include NC State (selector 800), football (selector 810), and basketball (selector 820). Thus, the local participant may select any of the selectors 800-820 to be presented with a prioritization or grouping of other participants that are currently in the video conference and that have the same inferred interest.

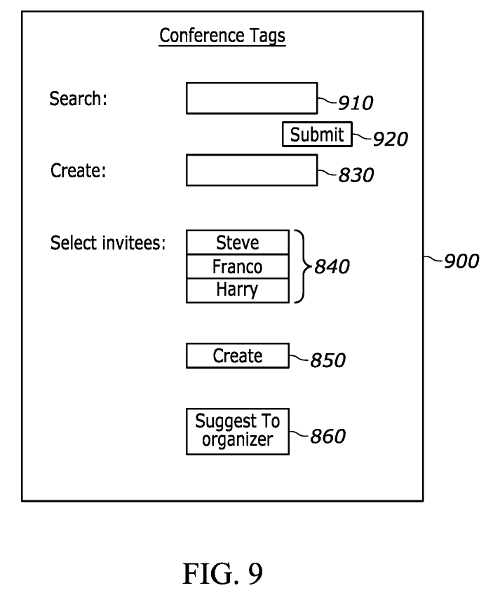

A selector 830 may also be presented on the GUI 800. The selector 830 may be selectable for the local participant to search for still other tags to connect with other participants, and/or to establish their own tag for connecting with other participants. Selection of the selector 830 may therefore command the local participant’s client device to present the GUI 900 of FIG. 9.

As shown in FIG. 9, the GUI 900 includes a search box 910 into which the local participant may enter a keyword (e.g., via hard or soft keyboard). The participant may then select the submit selector 920 to command the video conferencing system to search the available tags of the conference for one corresponding to the entered keyword, with the available tags being autonomously determined by the system using natural language processing, semantic understanding, and/or other techniques.

Additionally, to create a new metadata tag, the participant may enter a keyword or tag into the input box 830. The participant may even invite other remote participants to indicate their own interest in the same topic entered into box 830 by selecting one or more of the selectors 840, each for a different remote participant currently logged into the video conference. However, selection of one or more selectors 840 need not necessarily occur, but in either case the local participant may then select the create selector 850 to then create the metadata tag for themselves and others to select during the video conference.

In addition to or in lieu of creating the metadata tag themselves, the local participant may also select the selector 860 to send a request to the conference organizer or moderator for the organizer/moderator to then authorize the tag entered into box 830 for implementation in the conference. In some non-limiting examples, organizer/moderator authorization might even be required rather than letting individual participant attendees create metadata tags themselves.

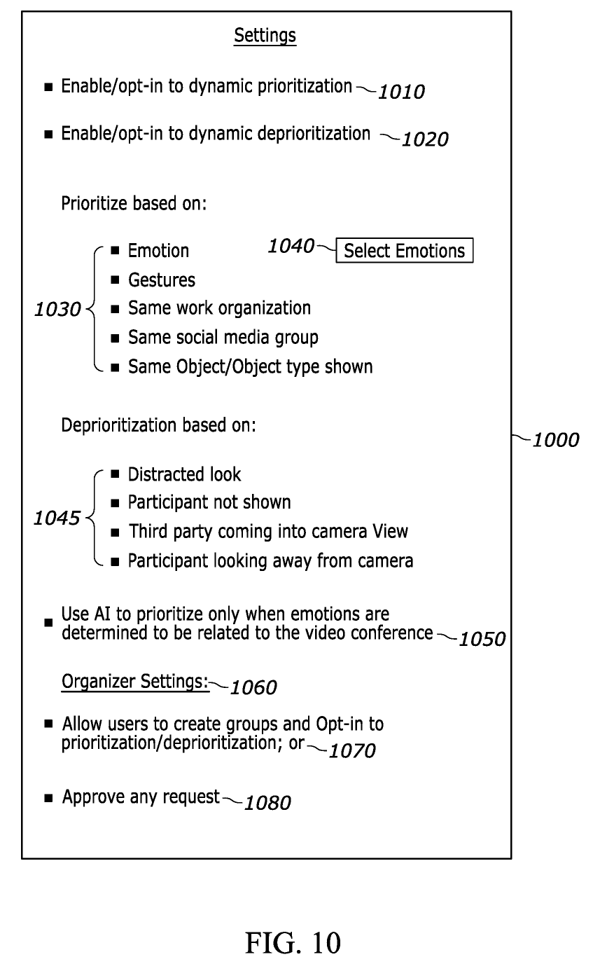

Continuing the detailed description in reference to FIG. 10, it shows an example GUI 1000 that may be presented on a display for an end-user to configure one or more settings of an apparatus/video conferencing application (“app”) to operate consistent with present principles. The GUI 1000 may therefore be presented to opt-in to various aspects mentioned above for all future video conferences rather than while entering a single video conference as already discussed above. Also note that each option discussed below may be selected by selecting the respective check box shown adjacent to that option, whether through cursor input, touch input, or another type of input.

As shown in FIG. 10, the GUI 1000 may include a first option 1010 that is selectable to command the apparatus to enable or opt-in the respective participant for prioritizing, deprioritizing, and/or grouping that participant’s video during multiple future video conferences. Therefore, the option 1010 may be selected a single time to set or configure the apparatus to, for multiple future video conferences, undertake one or more of the actions described above in reference to FIGS. 2-9. In some examples, another option 1020 may also be presented and may be selectable to enable or opt-in to dynamic deprioritization in particular. Thus, the option 1010 may be a global opt-in to all three of prioritization, deprioritization, and grouping, while in other examples it may be an opt-in only for prioritization and/or grouping while the option 1020 may be presented for deprioritization specifically.

FIG. 10 also shows that different first criteria may be listed for selection as criteria to use for prioritization consistent with present principles. Any prioritization criteria discussed herein may be listed as a respective option 1030 for selection, but in the present instance respective options 1030 have been listed for emotion, gestures, same work organization, same social media group, and same object/object type being recognized from video. If desired, the participant may also select the selector 1040 to select different particular emotions to use to prioritize video when recognized (from another GUI overlaid on the GUI 1000, for example).

Similarly, FIG. 10 also shows that different third criteria may be listed for selection as criteria to use for deprioritization consistent with present principles. Any deprioritization criteria discussed herein may be listed as a respective option 1045 for selection, but in the present instance respective options 1045 have been listed for distracted looks, the respective participant not being shown in the video itself, a third party coming into the local camera’s view, and the relevant participant looking away from the camera.

Still further, the GUI 1000 may include an option 1050 that may be selectable to command the apparatus to use artificial intelligence (AI) as set forth herein to prioritize video only when emotions of the relevant video’s participant are determined to be related to the video conference itself. Therefore, option 1050 may be selected to specifically command the apparatus to execute the functions in relation to decision diamond 530 of FIG. 5 as discussed above.

Also in some examples, a special section 1060 for conference organizers/moderators may be presented. The section 1060 may provide the organizer/moderator greater control over future conferences that they organize and/or initiate. As such, an option 1070 may be selected to allow other participants to themselves create groups/metadata tags as discussed above and to allow participants to opt in to prioritization/deprioritization without organizer authorization. Conversely, the organizer/moderator might wish to retain greater control over future conferences and, as such, may instead select the option 1080 to command the apparatus to instead have the organizer/moderator approve any such requests to create groups/metadata tags and to opt in (or out) of prioritization/deprioritization.

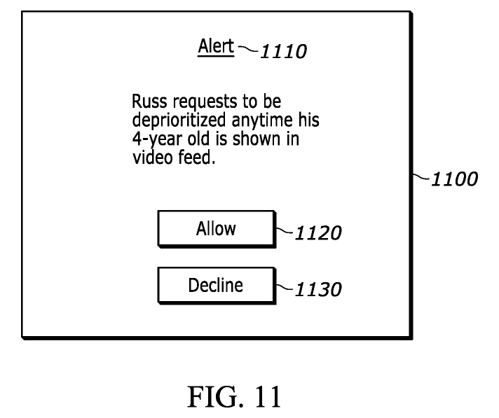

Therefore, FIG. 11 shows an example GUI 1100 that may be presented to an organizer/moderator during a video conference based on the option 1080 already being selected. The GUI 1100 includes a prompt or alert 1110 indicating that a particular non-organizer, non-moderating participant is requesting to be deprioritized when a particular criterion is satisfied, which in this case is anytime the participant’s 4-year old child is shown in the participant’s video feed. Selector 1120 may therefore be selected to permit that deprioritization, while selector 1130 may be selected to decline to permit that deprioritization.

Moving on from FIG. 11, it is to be understood that video conferencing consistent with present principles may take place through different platforms, including a web-based portal, a website, a dedicated video conferencing app executing at each participant’s client device, etc. But each participant’s video feed may still be a live, real-time video feed even if different participants are using ones of those different platforms for a given conference (and/or even different video conferencing services) to participate in the video conference.

It is to also be understood consistent with present principles that another criterion for deprioritization of video may be a given participant being on mute/having their local microphone muted so that audio data of that participant speaking is not transmitted to other client devices of other video conference participants. So, for example, if computer vision is executed on the video feed of that participant to determine that the participant is speaking but has their microphone muted, the system may deprioritize their respective video feed in response.

Also note that video of a given participant may be deprioritized where natural language processing is executed to determine that unmuted speech indicated in the user’s microphone input is not related to a topic of the video conference itself. So here, that participant’s video feed may be deprioritized and/or the system may autonomously mute the participant as well so that other participants do not hear the speech unrelated to the video conference. This might be particularly useful when, for example, the local participant audibly directs speech to a non-participant within their local environment rather than to the other remotely-located video conference participant(s) themselves.

Also note consistent with present principles that video conference participants may include participants calling in by phone, even if their respective client devices are not transmitting video owing to those participants calling in via a phone number rather than logging in for Internet streaming of their audio/video feeds. Video conference participants may further include Internet streaming participants who have their local video feed turned off (e.g., temporarily based on user command), or that are otherwise not transmitting local video, whilst still transmitting audio data (e.g., audio data from which an emotion may be inferred to then prioritize a blank or black box for that participant where their video feed would otherwise appear).

It may now be appreciated that present principles are directed in part to different ways to prioritize/group participant videos. Reactions like facial expressions/emotional reactions may be used, as may the fact that two participants already know each other (e.g., as determined through social media connections/friend lists and groups).

Therefore, the video conferencing system may monitor forms of emotion (e.g., happy, sad, excited) and categorize those participants that display similar emotions over a period of time. The system can, for example, group happy people together, sad people together, etc. Additionally, some emotions might trigger immediate prioritization among the entire group of participants (e.g. laughing, crying, cheering, etc.). The system might also deprioritize distracted attendees or off-screen attendees, attendees looking in a different direction, attendees where someone new comes into view, etc. Further, the user might opt-in to deprioritize their feed if a distraction occurs, such as child in room, someone walking up to them, etc. The opt-in may be enforced by the meeting organizer, a corporate policy, and/or an end-user preference so their feed is not prioritized in selected scenarios.

Eye tracking combined with emotion recognition may also be used to detect if an emotion is related to the meeting or related to something in the respective attendee’s environment instead. So, for example, if the attendee is determined to be looking at their display (and hence the video conference GUI 200) or looking their camera, either of which may be determined through eye tracking, the system may infer the concurrently expressed emotion as related to the video conference. Conversely, if the attendee is identified through eye tracking as looking elsewhere, the system may infer the concurrently expressed emotion as not related to the video conference. Thus, the same emotion in different contexts could mean prioritization when related to the conference and deprioritization when not related to the conference.

Additionally, attendees may be categorized/grouped together if they all have pets (e.g., as shown in their videos) or if they all have the same type of pet (e.g., dog or cat). Attendees may also be categorized/grouped together if they each have a baby or toddler in-arm. Other common interests may also be detected via each local attendee’s camera or microphone.

What’s more, in terms of grouping, attendees may be grouped/categorized by shirt color, hair color, age, gender, detected logos, phone brands used for the conference (e.g., iPhone vs Android), etc. Grouping and prioritizations may also occur based on attendee metadata such as organization membership, social media likes, similar social media groups, etc.

Preferred and non-preferred groups may also be implemented. For example, one group in a college online class may include those attendees who are sleeping, not paying attention, and/or that are distracted. Distracted groups might therefore contain participants with eyes that wander outside of a slide presentation being shared in the online class, wander outside the video of those in the video conference, and/or wander outside of related materials/windows shown as part of the conference. Then active attendees of the college online class may be placed in another group based on those people maintaining eye contact with the camera or other conference-related item a certain minimum percentage of the total conference time (e.g. thirty percent).

What’s more, there might be instances where multiple attendees are physically present in the same room and are using the same client device/camera to collectively participate in the video conference. Here, for example, eye tracking of participants may be different since the dynamics of the participants in the same room would be different (e.g., those people might be looking at a projection screen, at other in-person attendees, etc. and still be engaged in the conference and hence should not be deprioritized as they might otherwise be upon being determined as looking elsewhere when remote from others). Thus, camera-based knowledge of the room layout in combination with camera-based eye tracking may be used to determine if the participant is in fact engaged with an object associated with the video conference even if not looking at the local camera itself.

The system may also group participants in real-time during the video conference by letting each participant select a number for themselves (e.g. one to five fingers being held up, corresponding to breakout sub-conferences one to five), and then participants may be grouped into sub-conferences based on which number they hold up. Additionally, if too many people select the same sub-conference number, those sub-conferences could have a cap and once filled the system could ask a later-gesturing user to select a sub-conference/breakout room. Other gestures may also be used for grouping users together for sub-conferences that are apart from the primary conference.

Referring back to opt-ins again, opt-ins may occur upfront/beforehand and/or in real-time during a video conference. For example, one user might get a popup that says, “I see you have an NC State mug on your desk. There’s seven other NC State grads in the meeting. Would you like to enable ‘Smart Video Tagging’ to interact with the other grads with similar or common interests?” Opting in could then allow that user to view other participant’s tags, be groped automatically and/or have the NC State group presented to them (and/or only allow the organizer to view that data rather than the other participants themselves).

The system may also create list of detected tags per-participant as gathered by various methods discussed above. The system can then show different tags on a per-participant basis and let users search on those tags, create custom groups in the conference, suggest groups to the organizer, etc.

As also mentioned above for the section 1060 of FIG. 10, the system may even include a policy for the organizer and/or organization to allow any and all of the features above to be enabled for all attendees, or to approve any user-requested actions related to prioritization, deprioritization, and/or grouping. E.g. the organizer might get prompted that, “Russ requests to be deprioritized anytime his 4-year old hops in his lap”. Or maybe Russ wants to be prioritized based on that and can indicate as much to the system.

It may now be appreciated that technical improvements to video conferencing systems may be realized according to present principles. Participants may thus avoid missing important visual cues from other participants that might indicate the other participant’s own participation and engagement in the video conference despite the other participant not actively speaking. Present principles also help solve latency between switching active speakers since certain non-verbal visual cues may precede speech and be used to preemptively switch the active window to that user (e.g., the user smiles and is classified as happy before speaking about whatever subject is making them happy). Additionally, false positives in video prioritization may be avoided by using more than one prioritization criteria at the same time to then prioritize a user in response to multiple criteria being met but not a single criteria.

In one particular aspect, an apparatus and method consistent with present principles may operate substantially as shown and described above, but may also be claimed as including some but not all aspects in any intermediate claim approach (e.g., only one first criteria for prioritization may be established in a claim, or any combination of first criteria may be established in a claim).

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein.

What is claimed is:

1. An apparatus, comprising:
a processor system; and
storage accessible to the processor system and comprising instructions executable by the processor system to:
facilitate a video conference; and
during facilitation of the video conference, prioritize presentation of first video of a first video conference participant over second video of a second video conference participant based on one or more criteria other than the first video conference participant speaking and/or other than a client device of the first video conference participant transmitting audio data indicating the first video conference participant as speaking.

2. The apparatus of claim 1, wherein the one or more criteria comprise the first video conference participant expressing an emotion selected from the group consisting of: laughter, happiness, sadness, crying, cheering.

3. The apparatus of claim 2, wherein the instructions are executable to:
determine, in a first instance, that the emotion the first video conference participant is expressing is related to the video conference; and
based on the determination in the first instance, prioritize presentation of the first video.

4. The apparatus of claim 3, wherein the instructions are executable to:
determine, in a second instance, that the emotion the first video conference participant is expressing is not related to the video conference; and
based on the determination in the second instance, not prioritize presentation of the first video.

5. The apparatus of claim 1, wherein the instructions are executable to:
group different video of different respective video conference participants into two groups for presentation, a first group of the two groups comprising video of video conference participants classified as happy and a second group of the two groups comprising video of video conference participants classified as sad; and
present the first and second groups separately from each other on a graphical user interface (GUI) of the video conference.

6. The apparatus of claim 1, wherein the instructions are executable to:
deprioritize third video of a third video conference participant based on the third video conference participant being classified as distracted.

7. The apparatus of claim 1, wherein the instructions are executable to:
deprioritize third video of a third video conference participant based on the third video conference participant not being currently shown in the third video.

8. The apparatus of claim 1, wherein the instructions are executable to:
deprioritize third video of a third video conference participant based on the third video conference participant being identified as looking in a direction away from a camera that generates the third video.

9. The apparatus of claim 1, wherein the instructions are executable to:
deprioritize third video of a third video conference participant based on another person besides the third video conference participant coming into view in the third video.

10. The apparatus of claim 1, wherein the one or more criteria comprise the first video conference participant making a gesture, the gesture comprising: a hand raise gesture, a thumbs up gesture.

11. The apparatus of claim 1, wherein the one or more criteria comprise the first video conference participant being a member of a same organization as a third video conference participant, the first video prioritized as presented to the third video conference participant but not prioritized for a fourth video conference participant of the video conference.

12. The apparatus of claim 1, wherein the one or more criteria comprise the first video conference participant and a third video conference participant being members of a same social media group, the first video prioritized as presented to the third video conference participant but not prioritized for a fourth video conference participant of the video conference.

13. The apparatus of claim 1, wherein the one or more criteria comprise the first video and third video of a third video conference participant both showing a same object and/or showing respective objects of a same object type.

14. The apparatus of claim 1,wherein the apparatus comprises one or more of: a server facilitating the video conference at least in part by routing audio video communications between client devices of respective video conference participants, a first client device facilitating the video conference by transmitting local audio video to the server and/or to other client devices of other respective video conference participants.

15. The apparatus of claim 1, wherein prioritizing presentation of the first video over the second video comprises one or more of: presenting the first video higher up on a graphical user interface (GUI) than the second video, presenting the first video larger on the GUI than the second video, presenting the first video more to the left than the second video according to a video listing, presenting the first video on the GUI but not concurrently presenting the second video on the GUI, highlighting the first video on the GUI, the highlighting comprising one or more of: presenting a first color along a border of the first video, presenting a graphic overlay in relation to the first video.

16. A method, comprising:
facilitating a video conference; and
during facilitation of the video conference, prioritizing presentation of first video of a first video conference participant over second video of a second video conference participant based on one or more criteria other than the first video conference participant speaking, the one or more criteria comprising the first video conference participant visually and/or non-verbally expressing a particular emotion.

17. The method of claim 16, wherein prioritizing presentation of the first video over the second video comprises one or more of: presenting the first video higher up on a graphical user interface (GUI) than the second video, presenting the first video larger on the GUI than the second video, presenting the first video more to the left than the second video according to a video listing, presenting the first video on the GUI but not concurrently presenting the second video on the GUI, highlighting the first video on the GUI, the highlighting comprising one or more of: presenting a first color along a border of the first video, presenting a graphic overlay in relation to the first video.

18. The method of claim 16, comprising:
deprioritizing third video of a third video conference participant based on another person besides the third video conference participant coming into view in the third video.

19. The method of claim 18, wherein the third video conference participant is different from the second video conference participant.

20. An apparatus, comprising:
at least one computer readable storage medium (CRSM) that is not a transitory signal, the at least one CRSM comprising instructions executable by a processor system to:
facilitate a video conference; and
during facilitation of the video conference, prioritize presentation of first video of a first video conference participant based on one or more criteria other than the first video conference participant currently speaking.
